(19) United States
(12) Patent Application Publication
(10) Pub. No.: US 2014/0227559 A1
(43) Pub. Date: Aug. 14, 2014

(54) METHOD FOR MACHINING A METALLIC FRICTIONAL SURFACE USING LASERS; AND A CORRESPONDING SHEET-METAL PART

(71) Applicant: Schaeffler Technologies GmbH & Co. KG, Herzogenaurach (DE)

(72) Inventors: Stefan Steinmetz, Essingen (DE); Patrick Knecht, Muggensturm (DE)

(73) Assignee: SCHAEFFLER TECHNOLOGIES GMBH & CO. KG, Herzogenaurach (DE)

(21) Appl. No.: 14/254,021

(22) Filed: Apr. 16, 2014

Related U.S. Application Data
(63) Continuation of application No. PCT/DE2012/000962, filed on Oct. 4, 2012.

(30) Foreign Application Priority Data
Oct. 24, 2011 (DE) 102011085124.0

(51) Int. Cl. B23K 26/00; F16D 69/00; B23K 26/36

(52) U.S. Cl. CPC B23K 26/0084; B23K 26/367; F16D 69/00
USPC 428/687; 219/121.85; 219/121.69

(57) ABSTRACT

A method for machining a metallic frictional surface for wet-running applications is provided in which the metallic frictional surface is machined using a laser.

### INCORPORATION BY REFERENCE

The following documents are incorporated herein by reference as if fully set forth: International Application No. PCT/DE2012/000962, filed Oct. 4, 2012; and German Patent Application No. 10 2011 085 124.0, filed Oct. 24, 2011.

### BACKGROUND

The invention relates to a method for machining a metallic frictional surface for wet-running applications. The invention further relates to a sheet-metal part comprising at least one metallic frictional surface.

A method is known from the German publication DE 10 2010 025 403 A1 for the production of a frictional coating for a friction clutch having a coating material compressed to a carrier sheet metal, which is vaporized using a laser.

### SUMMARY

The objective of the invention is to simplify the processing of metallic frictional surfaces for wet-running applications and/or to improve the quality of metallic frictional surfaces for wet-running applications.

The objective is attained in a method for processing a metallic frictional surface for wet-running applications such that the metallic frictional surface is processed with a laser. Here, the laser processing can increase the performance of the metallic frictional surface and the operating behavior of the metallic frictional surface can be improved in wet-running applications. Furthermore, machining steps for cleaning and/or generating a metallic frictional surface can be omitted. In wet-running applications the metallic frictional surface constantly comes into contact with a liquid, such as oil.

A preferred exemplary embodiment of the method is characterized in that the metallic frictional surface of a counter sheet-metal is processed with a laser. In a wet-running clutch application the counter sheet-metal is connected in a friction-fitting fashion to the frictional coating of a plate and thus it is also called the counter plate.

Another preferred exemplary embodiment of the method is characterized in that the metallic frictional surface is cleaned with a laser. During the laser processing, by way of a targeted introduction of thermal energy, contaminants, such as oils, fats, or the like are removed from the metallic frictional surface.

Another preferred exemplary embodiment of the method is characterized in that microscopic and/or macroscopic structures/textures are introduced into the metallic frictional surface via laser processing. The macroscopic structures/textures can be detected with the naked eye without any optic means. The microscopic structures/textures can be detected with the help of a microscope. These structures/textures can particularly change the friction coefficient of the metallic frictional surface.

Another preferred exemplary embodiment of the method is characterized in that defined and/or undefined structures/textures are inserted into the metallic frictional surface by laser processing. By the defined structures/textures the flow behavior of a medium along the metallic frictional surface can be altered, for example.

Another preferred exemplary embodiment of the method is characterized such that the friction coefficient, the flow behavior, and/or the tribological features of the frictional surface can be altered in a targeted fashion using laser processing. Here, tribology represents the science of friction, lubrication, and wear and tear related to objects moved in reference to each other. The friction coefficient is also called friction factor. The flow behavior relates to the behavior of a frictional surface when a fluid and/or a liquid flows against or over it.

Another preferred exemplary embodiment of the method is characterized in that grooves and/or recesses are inserted into the metallic frictional surface via laser processing. The insertion of grooves into the metallic frictional surface yields the advantage that otherwise required grooves in the frictional coating cooperating with the counter plate can be omitted. Beads and/or weld spatter may develop in the edge regions of the recesses, which can be used for a targeted alteration of the friction coefficient of the metallic frictional surface.

Another preferred exemplary embodiment of the method is characterized in that a thermal deformation is introduced into the metallic frictional surface via laser processing in a targeted fashion. This allows for example to introduce a corrugation into a counter plate equipped with a metallic frictional surface.

Another preferred exemplary embodiment of the method is characterized in that the laser processing of the frictional surface is combined with an additional thermal treatment. This way, the design of the frictional surface and/or the counter plate structured and/or textured according to the invention can be further altered in an advantageous fashion.

The invention further relates to a sheet-metal part comprising at least one metallic frictional surface, which is processed with a laser according to the above-described method. The sheet-metal part preferably represents a counter frictional surface, particularly a counter plate or a counter frictional plate of a multi-disk clutch used in motor vehicles.

### BRIEF DESCRIPTION OF THE DRAWINGS

Additional advantages, features, and details of the invention are discernible from the following description, in which various exemplary embodiments are described in greater detail with reference to the drawing.

The single attached figure shows a surface structuring according to the invention in various views.

### DETAILED DESCRIPTION OF THE PREFERRED EMBODIMENTS

Multi-disk clutches, as the ones used in the automotive field, comprise a support sheet metal, to which friction coatings are fastened. The friction coatings are connected in a friction-fitting fashion to counter surfaces, also called counter plates or counter frictional plates, in order to transfer torque. The counter plates are preferably made from steel sheets.

According to an essential aspect of the invention, microscopic and macroscopic structures/textures are inserted into a frictional surface of the counter plate using a laser beam. Depending on requirements, defined and/or undefined structures/textures and/or designs are inserted into the counter plate by laser beams in order to alter the operating features, the performance of the clutch assembly, and other clutch operating parameters. Simultaneously the frictional surface is cleaned using the laser beam.

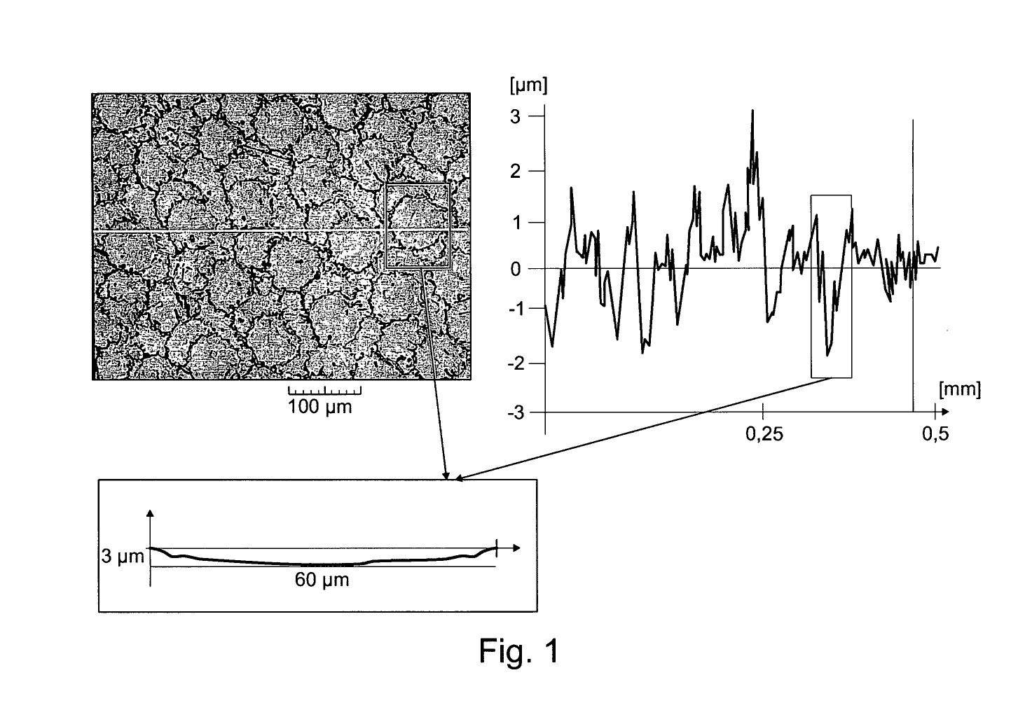

The attached FIG. 1 shows a surface structuring according to the invention of the frictional surface of a counter plate in various views. A laser system is used in order to generate surface structures with a Gauss distribution.

FIG. 1 shows a square scanning electron micrograph of the surface structuring generated by the laser system.

The surface structuring comprises a multitude of recesses, which are also called spots. The recesses show a depth of approximately 3 μm. The spot size amounts to approximately 60 μm. Beads or weld spatter may occur at the edge areas of the recesses.

Furthermore, FIG. 1 shows a Cartesian coordinate diagram with an x-axis and a y-axis. The roughness progression along a horizontal line in the scanning electron micrograph is shown in millimeters on the x-axis. The roughness progression along the line is shown in micrometers on the y-axis. The recesses are generated by the laser intensity distributed according to Gauss.

1. A method for processing a metallic frictional surface for wet-running applications, comprising processing the metallic frictional surface with a laser.

2. The method according to claim 1, wherein the metallic frictional surface is a counter surface formed from sheet-metal.

3. The method according to claim 1, wherein the metallic frictional surface is cleaned with a laser.

4. The method according to claim 1, further comprising inserting at least one of microscopic or macroscopic structures or textures into the metallic frictional surface via the laser processing.

5. The method according to claim 1, further comprising inserting at least one of defined or undefined structures or textures into the metallic frictional surface via the laser processing.

6. The method according to claim 1, further comprising altering at least one of a friction coefficient, a flow behavior, or tribological features of the frictional surface by the laser processing in a targeted fashion.

7. The method according to claim 1, further comprising inserting at least one of grooves or recesses into the metallic frictional surface via the laser processing.

8. The method according to claim 1, further comprising inserting thermal deformations into the metallic frictional surfaces using the laser processing in a targeted fashion.

9. The method according to claim 1,further comprising combining the laser processing of the frictional surface with an additional thermal treatment.

10. A sheet metal part with at least one metallic frictional surface, which is processed with a laser according to the method of claim 1.
